(19) United States
(12) Patent Application Publication
(10) Pub. No.: US 2011/0296305 A1
(43) Pub. Date: Dec. 1, 2011

(54) METHODS AND APPARATUS FOR MEDIA MANAGEMENT

(75) Inventors: Brian Orr, Cambridge (CA); Anton Jedlovsky, Waterloo (CA); Steven Brenneman, Waterloo (CA)

(73) Assignee: SONY CORPORATION, Tokyo (JP)

(21) Appl. No.: 12/791,806

(22) Filed: Jun. 1, 2010

(51) Int. Cl. G06F 3/048; G06F 17/30

(52) U.S. Cl. 715/716; 707/758; 715/810; 707/E17.101

(57) ABSTRACT

Methods and apparatus are provided for matching media files stored in a media player device to media files stored in a computing device. In one embodiment, a method includes scanning a media player device for one or more media files, detecting an identifier associated with each media file stored on the media player device, wherein identifiers are generated by a media management application, and checking if detected identifiers associated with media files stored in the media player device correspond to identifiers associated with media files stored in the computing device. The method may also include determining one or more graphical indicators for a user interface of the media management application based on said checking. According to another embodiment, a user interface may be provided for a media management application by a computing device.

### FIELD OF THE INVENTION

The present invention relates generally to processing media files, and more particularly to a device and methods for matching media files on a media player device to a computing device, and user interface representation of media files.

### BACKGROUND OF THE INVENTION

Managing a collection of media is typically performed using one or more programs for transferring and managing media on a device. Managing a media collection, however, can be difficult when a management program does not identify the media on a device. For example, some conventional applications may not recognize every media file stored on a media player. Similarly, the management program may not provide any means of identifying or reconciling media files that do not match between a library and a device. As a result, one drawback of the conventional approaches may be duplication of media files on a device. Another drawback may be that conventional management programs may not be able to manage the files, and in some cases may require that the user delete stored media in order to download media. Because management programs are typically directed to media of a single format, and these drawbacks cannot be reconciled by the conventional approaches.

Another drawback of conventional management programs relates to informing a user of media files identified on a media player. For example, conventional user interfaces typically allow for display of media associated only with a single source. Thus, these user interfaces, however, typically do not allow for user to view media that exists on a location that is not currently visible, such as a device that is not selected. Further, these user interfaces may also suffer from the drawbacks of identifying media files. Thus, there is a desire to improved management programs and a user interface that allow for improved management.

### BRIEF SUMMARY OF THE INVENTION

Disclosed and claimed herein are methods and apparatus for matching media files stored in a media player device to media files stored in a computing device. In one embodiment, the method includes scanning the media player device, by the computing device, for one or more media files, detecting an identifier associated with each media file stored on the media player device, wherein identifiers are generated by a media management application, and checking, by the computing device, if detected identifiers associated with media files stored in the media player device correspond to identifiers associated with media files stored in the computing device. The method further includes determining one or more graphical indicators for a user interface of the media management application based on said checking.

In another embodiment, a method is provided for providing a user interface for a media management application by a computing device. The method includes detecting, by the computing device, a connection to a media player device, matching, by the computing device, media files stored in the media player device to one or more media files stored in the computing device based on detection of one or more identifiers associated with files stored in the media player device, wherein identifiers are generated by a media management application, and determining one or more graphical indicators for the user interface of the media management application based on said matching. The method further includes displaying a user interface for the media management application based on said determining, wherein the user interface includes one or more graphical indicators.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a graphical representation of a media player device and computing devices according to one embodiment of the invention;

FIG. 2 depicts a process for matching media files stored by a media player to media files stored by a computing device according to one embodiment of the invention;

FIG. 3 depicts another process for matching media files stored by a media player to media files stored by a computing device according to one or more embodiments of the invention;

FIG. 4 depicts a simplified block diagram of a computing device according to one embodiment of the invention;

FIG. 5 depicts a graphical representation of a media library for a media management application according to one or more embodiments of the invention;

FIG. 6 depicts a graphical representation of a user interface of a media management application according to one embodiment of the invention;

FIGS. 7A-7B depict graphical representations of graphical indicators generated by a media management application according to one embodiment of the invention; and

FIG. 8 depicts a graphical representation of graphical indicators generated by a media management application according to another embodiment of the invention.

### DETAILED DESCRIPTION OF THE EXEMPLARY EMBODIMENTS

### Overview and Terminology

The present invention relates generally to management of media files. One aspect of the present invention is directed to matching media files stored by a media player to one or more media files stored by a computing device. In one embodiment, a process is provided to match one or more media files of a media player device to files associated with a library of a computing device based on one or more identifiers. Each media file associated with a library of the computing device and the media player may be assigned a unique identifier. For example the identifier may be assigned to media files when added to the library of the computing device. Alternatively, or in combination, identifiers may be assigned to media files of the media player during transfer of the media files relative to the media player (e.g., downloading and uploading of files relative to the media player device). Accordingly the process may involve scanning the media player device, and matching one or more media files. Based on matching, the process may further include performing additional acts to identify and/or provide media files with an identifier.

Another aspect of the invention is directed to providing a user interface for a media management application to represent media files. In one embodiment, a media management application may include a user interface configured to display one or more graphical indicators to improve management of media. The media management application may be configured to perform a process for displaying one or more graphical indicators. According to another embodiment, the media management application may additionally be configured to allow for display of one or more graphical indicators, while displaying media associated with a selected source, to represent files that exist on a location that is not visible and separate from the selected source.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

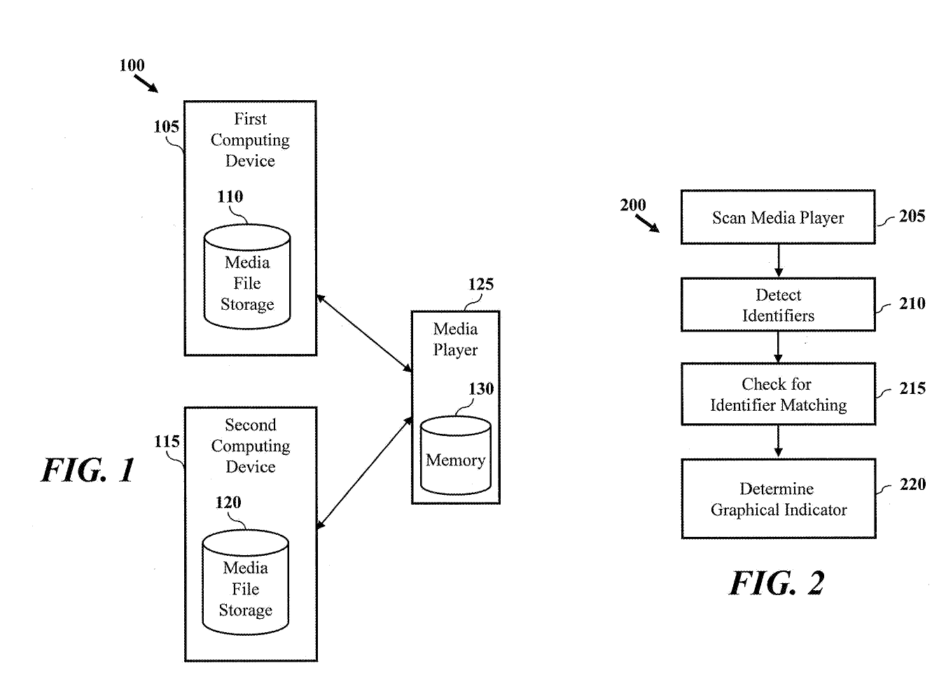

Referring now to the figures, FIG. 1 depicts a graphical representation of a media player device and a computing device according to one embodiment of the invention. In one embodiment, a first computing device 105 may be configured to interface with media player device 125. Files stored in media player device 125 may be matched to one or more files on one or more computing devices. According to another embodiment, matching media files may be employed for a user interface of the media management application of a computing device, such as first computing device 105. One advantage of media matching as described herein may be to allow for managing media stored on a media player device which interfaces with a plurality of computing devices.

As depicted in FIG. 1, first computing device 105 includes media file storage 110 to store one or more media files. First computing device 105 may be configured to interface with media player device 125 to provide one or more media files and management of the device. In one embodiment, first computing device 105 may be configured to execute a media management program to provide a user interface for managing media files of media player device 125. Media player device 125 may be configured to store a plurality of media files, such as audio, video, and media data in general in memory 130. According to another embodiment, the media management application may be configured to provide one or more graphical indicators to a user based on one or more media files stored on media player device 125 provided by another computing device.

As depicted in FIG. 1, media player device 125 may be configured to communicate with second computing device 115 to receive one or more media files based on media file data stored in memory 120. Accordingly, a media player application may allow for interoperation of media player device 125 with one or more computing devices to allow for management of media.

As will be discussed in more detail with respect to FIG. 2, a process is provided for matching one or more files of the media player device to media files stored on a computing device using identifiers, such as media player 125 and computing device 105. According to another embodiment, a process may be provided for providing identifiers to one or more media files stored by a media player to notify a user of files stored by the media player device. In that fashion, a media management application on a computing device, such as computing device 105 or computing device 115 can provide one or more graphical indicators to assist a user in determining media stored on a media player. In addition, a computing device executing the media management application may assign one or more roaming identifiers to a media file associated with one or more devices.

Referring now to FIG. 2, a process is depicted for matching media files stored by a media player to media files stored by a computing device according to one embodiment of the invention. Process 200 may be performed by a media management application of a computing device (e.g., computing devices 105 or 115) and may be initiated by the computing device scanning a media player at block 205. In one embodiment, the computing device may be configured to scan a media player when the media player device is coupled to the computing device (e.g., computing device 105). Scanning of the media player may correspond to detecting media files and reading one or more identifiers, wherein each media file includes an identifier. According to one embodiment of the invention, when a media player is first attached to a computing device, an identifier may be assigned to each media file of the device by the computing device. In one embodiment, identifiers may relate to coded patterns generate d by the media management program as 128 bit codes. In that fashion, identifiers may be provided for a plurality of media types. According to another embodiment, identifiers may be stored with media files as non media data, such as header data. Scanning at block 205 may further include reading one or more storage locations of the media player, detecting a media file table of the media player, and/or reading media files from removable memory of the media player.

At block 210, the computing device may then check for identifiers for each media file. As will be discussed further below, if the media file does not have an identifier, the media management application may assign the media file an identifier. Identifiers associated with each media file may relate to a persistent identification code which uniquely identifies the media file for a plurality of computing devices configured to execute the media management application. Process 200 may continue by checking for identifier matches at block 215. Checking for matching identifiers may relate to comparison of identifiers of the media files stored by the media player application to identifiers of media files stored on the computing device. In addition, checking may include comparing identifiers associated with media files stored in the media player device to a table of identifiers stored in the library of the computing device. Based on identifier checking at block 215, process 200 may continue by determining graphical indicator display at block 220. For example, the media management application may be configured to display one of more media file names on a user interface and one or more graphical indicators to indicate that media files stored on a selected device are associated with content in the library of the computing device. Display of the graphic indicator may be based on a media source selected by the user and one or more media files selected by the user stored on the computing device.

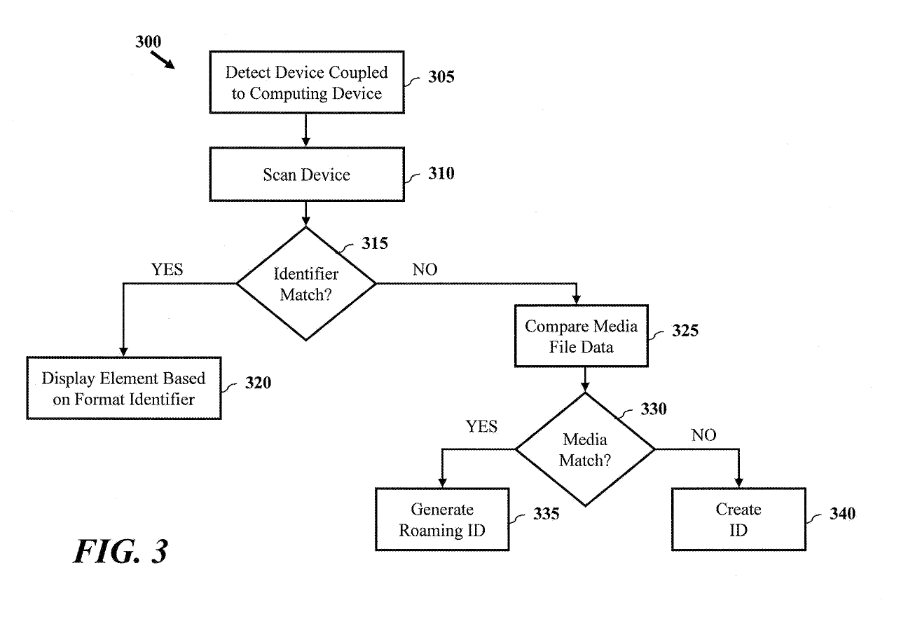

One advantage of the invention over conventional methods may be that the media management application can attempt to determine identifiers for media files of the media player when the media files do not include an identifier. According to another embodiment, media files may be given roaming identifiers when media files match, but have different identifier values. As depicted in FIG. 3, another process is provided for matching media files stored by a media player to media files stored by a computing device according to one or more embodiments of the invention. Process 300 may be performed by the computing device (e.g., computing device 105) executing a media management application. Process 300 may be initiated by detecting a device coupled to the computing device at block 305. The computing device may then scan the media player application at block 310 to determine one or more media files and/or identifiers associated with the media files.

Based on the media files detected and media file identifiers, a media management application executed by the computing device may then check for one or more identifier matches. When an identifier match is determined (“YES” path out of decision block 320), the computing device may then determine a display element based on the identifier. When an identifier match is not present for a media file (“NO” path out of decision block 315), the computing device may then attempt to determine if the media file corresponds to a media file stored by the computing device at block 325.

In one embodiment, the computing device may intelligently determine if the media file matches a media file on the computing device. For example, the computing device may compare a file size and/or date of modification of the media file to corresponding elements of media files stored by the computing device. Alternatively, and/or following comparison of file size, the computing device may then compare one or more of album, artist, and track title match (e.g., for audio files) at block 325. According to another embodiment, the computing device may compare one or more of file name, data taken, and file size match (e.g., for media such as photos and video files) at block 325. Based on the comparison at block 325, the computing device may determine if the media file matches a media file on the computing device at decision block 330.

When the media file matches a media file on the computing device (“YES” path out of decision block 330), the computing device may then assign a roaming identifier from a media library for the media file at block 335. A roaming identifier may be assigned to the media files of the media player device such that a media management program can provide display data for a user. Further, the roaming identifier may allow for media file stored in the media player device to be read by a plurality of computing devices (e.g., computing devices 105 and 115) and devices executing the media management application.

When the media file does not match a media file on the computing device (“NO” path out of decision block 330), the computing device may then create an identifier for the media file at block 340. In certain embodiments, process 300 may include modifying an identifier of a media file such that the media file may be identifier by the media management application. For example, the identifier may be replaced with a new 128 bit code.

Although FIG. 3 has been described above with reference to matching media files, it should also be appreciated that this process, and the systems and processes as described herein, may be employed for matching files relative to one or more computing devices. In one embodiment, process 300 may be employed for matching one or more files between computing devices which may be coupled via a network connection (e.g., wired or wireless). For example, a computing device (e.g., computing device 105) may be configured to interface with at least one other computing device (e.g., second computing device 115) to match one or more files on at least one or more computing devices (e.g., “cloud” storage computers, computing devices in general, etc.). Based on file matching between computing devices, a computing device executing a management application, such as the media management application, may provide one or more graphical indicators on a user interface to identify one or more matching files. File matching may thus allow for synchronization of files (including media files) to computing devices via a network connection (e.g., an external web service or other networked computer). In an exemplary embodiment, users desiring to compare files on a computing device may employ a management application employing one or more processes as described herein to compare the files with networked file storage. The management application may then display one or more graphical indicators to identify files that exist on the external storage.

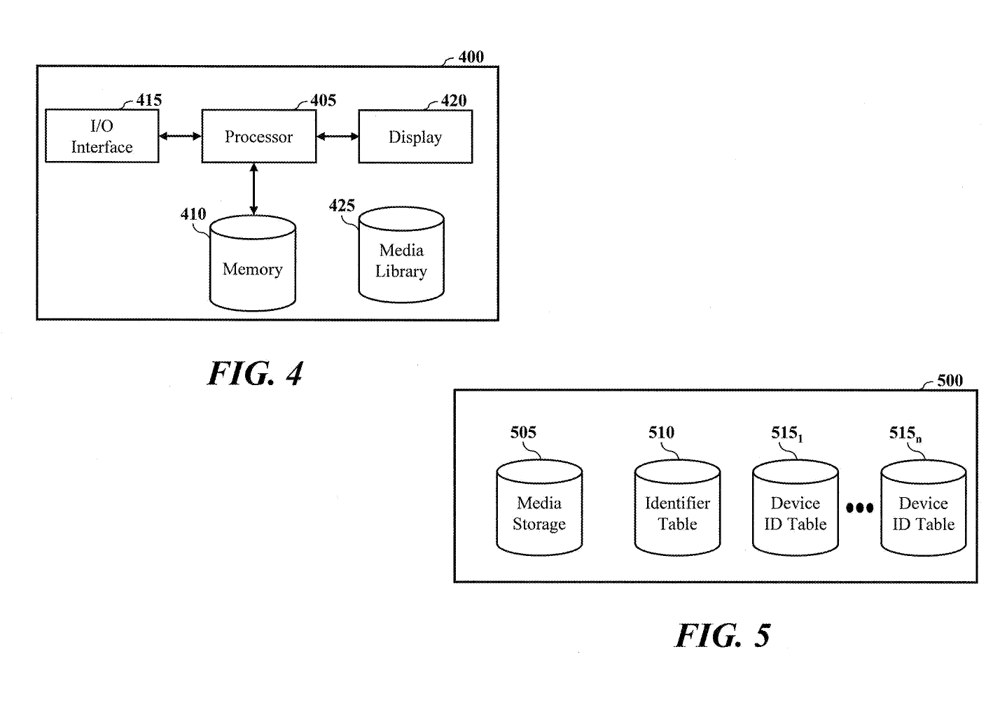

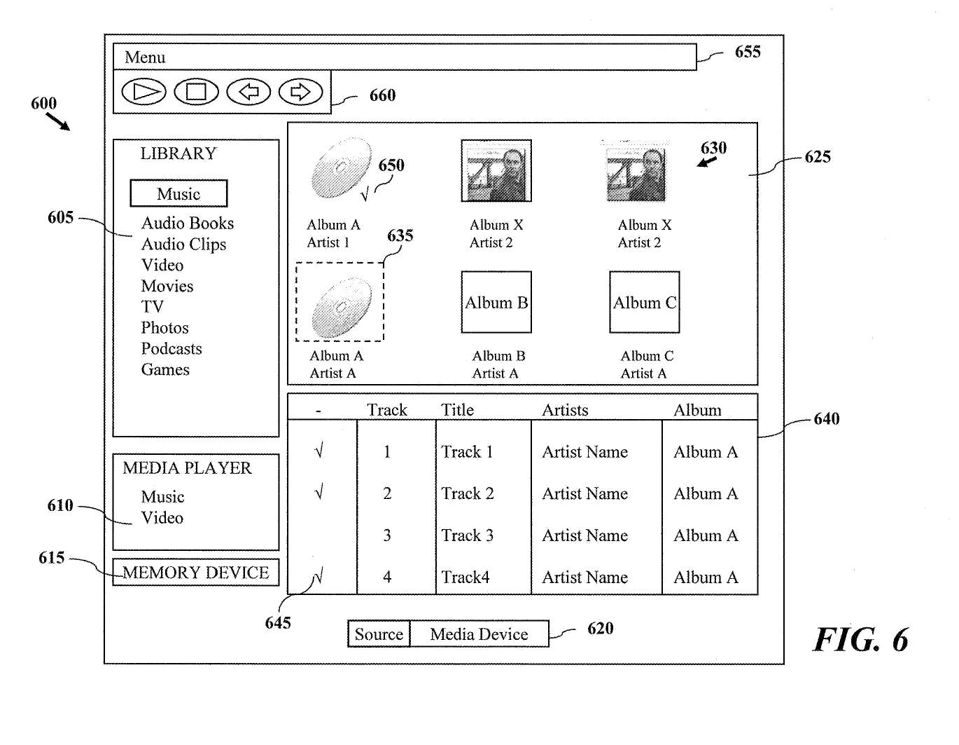

FIG. 4 depicts a simplified block diagram of a computing device according to one embodiment of the invention. In one embodiment, computing device 400 relates to a personal computing device that may be employed by a user to manage one or more media files. In addition, computing device 400 may be employed to download, and/or upload, one or more media files relative to a media player. As shown in FIG. 4, computing device 400 includes processor 405, memory 410, input/output (I/O) interface 415, and display 420. Processor 405 may be configured to control operation of computing device 400 based on one or more computer executable instructions stored in memory 410, including a media management application to provide management and matching of one or more media files. Memory 410 may relate to one of RAM and ROM memories and may be configured to store one or more media files, and computer executable instructions for operation of computing device 400. As will be described below in more detail with respect to FIG. 6, processor 405 of computing device 400 may execute a media management application configured to provide media matching of one or more media files, and display of a user interface including one or more graphical indicators.

I/O interface 415 may include one or more buttons for user input, such as a numerical keypad, volume control, channel control, menu controls, pointing device, track ball, mode selection buttons, and playback functionality (e.g., play, stop, pause, forward, reverse, slow motion, etc). In that fashion, a user of computing device 400 can command a media management application, including an application for seamless playback of one or more media files. Buttons of I/O interface 415 may include hard and soft buttons, wherein functionality of the soft buttons may be based on one or more applications running on computing device 400. I/O interface 415 may be configured to allow for one or more devices to communicate with computing device 400 via wired or wireless communication, such as a media player device (e.g., media player device 125).

Display 420 may be employed to display one or more of a user interface of the media application player, menu functions, media tracking, media file identifiers, sources of media files, etc. Display 420 may further be configured to display data received from one or more devices, such as a peripheral device, and external memory.

Computing device 400 may be configured to manage a plurality of media files. In one embodiment, computing device 400 may include media library 425 to store media files for one or more media player devices. For example, media library 425 may store photos, audio data, video data, gaming files, electronic text files, and media in general. As will be discussed below with respect to FIG. 5, media library 425 may include one or more device tables including identifiers associated with one or more media devices. According to another embodiment, computing device 400 may be configured to provide one or more media files stored on an external device (e.g., portable hard drives, removable memory, portable media players, etc.) for a media player. I/O interface 415 may include one or more ports for receiving media data, including ports for removable memory. In another embodiment, computing device 400 may include one or more optical drives, not shown in FIG. 4, which may be configured to detect and decode one or more media files stored on a disc (e.g., CD, DVD™, Blu-ray™, etc.).

Referring now to FIG. 5, a graphical representation is depicted of a media library for a media management application according to one or more embodiments of the invention. Media library 500 may relate to a media library (e.g., media library 425) of a computing device. In another embodiment, media library 500 may be stored on memory (e.g., memory 410) of a computing device. Media library 500 includes media storage 505, identifier table 510, and one or more device identifier table 515₁₋ₙ. Media storage 505 may be configured to store one or more media files, including photos, audio data, video data, gaming files, electronic text files, and media in general. Storage of the media files in single location may facilitate media matching. According to another embodiment, identifier table 510 of media library 500 includes an identifier for each media file stored in media storage 505. In certain embodiments, a media management application may check match media files for a media player based on one ore more identifiers stored in identifier table 510.

According to another embodiment, media library 500 may store one or more identifiers of media files stored by a plurality of media players. Device identifier tables 515₁₋ₙ may be generated by a media management application when a device is coupled to a computing device executing the management application. Based on scanning of the media player by the computing device, a device identifier table, such as 515₁, may be created to include one or more identifiers. Media matching may then be performed based on identifiers provided in device identifier table 515₁ and identifier table 510. One advantage may be to allow for determining media files of the media player without requiring subsequent detections and interrogation of the media player during a session of the media management application. Further, one or more graphical indicators may be displayed based on data stored by media library 500.

Referring now to FIG. 6, a graphical representation is depicted of a user interface of a media management application according to one aspect of the invention. According to one embodiment, a user interface of media management application may represent files associated with one or more locations. One advantage of the user interface may be to provide one or more graphical indicators to represent files that exist on a location that is not currently visible.

As depicted, user interface 600 of the media management application includes library window 600. Library window 600 may provide one or more display elements associated with types of media files stored by a computing device (e.g., computing device 400), such as music, audio books, audio clips, video files/clips, movies, photos, podcasts, games, etc. Based on a user selection of a media type in library window 605, user interface 600 may display one or more media files. As depicted in FIG. 6, music files are selected, shown as 608.

User interface 600 may further include one or more windows that may be associated with devices include media files. As depicted in FIG. 6, user interface 600 includes media player window 610. Media player window 610 may include one or more graphical elements associated with media files stored on the media player device (e.g., media player device 125), such as music, video, etc. According to one embodiment, user selection of a graphical element in media player window 610 may initiate display of one or more media files in a window of user interface 600. User interface 600 may similarly include one or more additional device windows, such as memory device window 615. According to another embodiment, user interface 600 may include a menu 620 which may be employed by the user to select one or more devices scanned by the media management application, such as devices associated with media player device window 610 or memory device window 615.

Based on a user selection, in this case music element 608 of library window 605, the user interface 600 may display one or more graphical elements associated with one or more media files. As depicted window 625 may include one or more graphical elements associated with albums, shown as 630, for one or more media files. Albums 630 may be illustrated in window 625 as a generic disc element, or may include album art. Window 625 may allow for user selection of an album. When an album is selected, window 625 may display a graphical indication such as highlighting or outlining the selected album, shown as 635. Based on the selection, the user interface may display one or more media files (e.g., tracks) associated with the album in window 640.

Window 640 may display one or more files associated with album 635 selected by the user. As depicted, media files of Album A, shown by selection 635, stored by the library of the computing device are listed in window 640. According to one embodiment of the invention, the user interface may display one or more graphical indicators indicating to represent the existence of files on a device. For example, based on user selection of a media player in menu 620, and selection of an album in window 625, the media management application may display one or more graphical indicators, such as 645. Display of a graphical indicator 645 may indicate that a media file of the computing device library is additionally stored on the device indicated in menu 620. In that fashion a user can be notified of media files that are stored on the media player, even though media files of the user device are not selected. Display of the graphical indicator may be based on the process of media matching as described above with relation to FIG. 2.

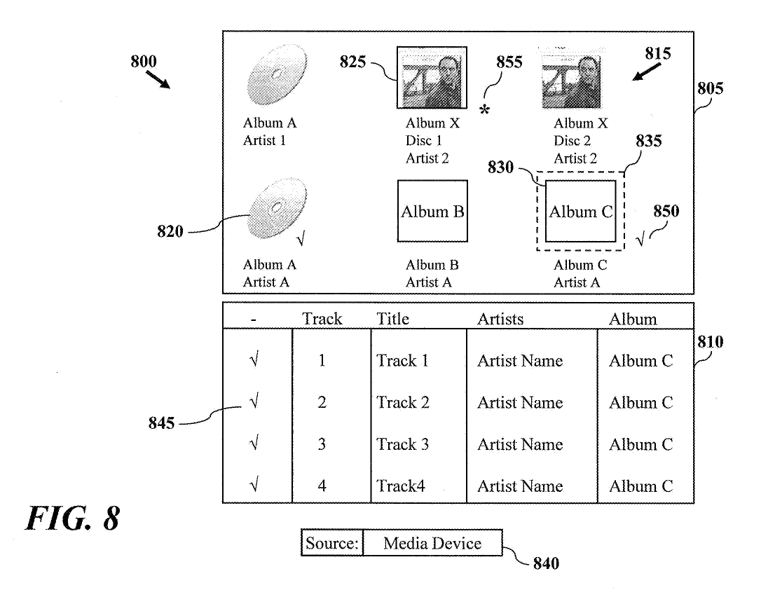

According to another embodiment, a graphical indicator may be displayed in window 625 to indicate that an entire album is stored on the media player device, shown as 650. As will be described below in more detail with respect to FIG. 8, one or more graphical indicators may be displayed to indicate partial or full storage of media files associated with an album by the media player device.

User interface 600 of the media management application may further include menu bar 655 for selection of one or more functions of the media management application. Further, user interface may display playback commands, shown as 660, to playback of one or more media files by a user. Although not shown, user interface may include one or more graphical elements to allow for coping media files between libraries, adjusting volume adjustment, etc.

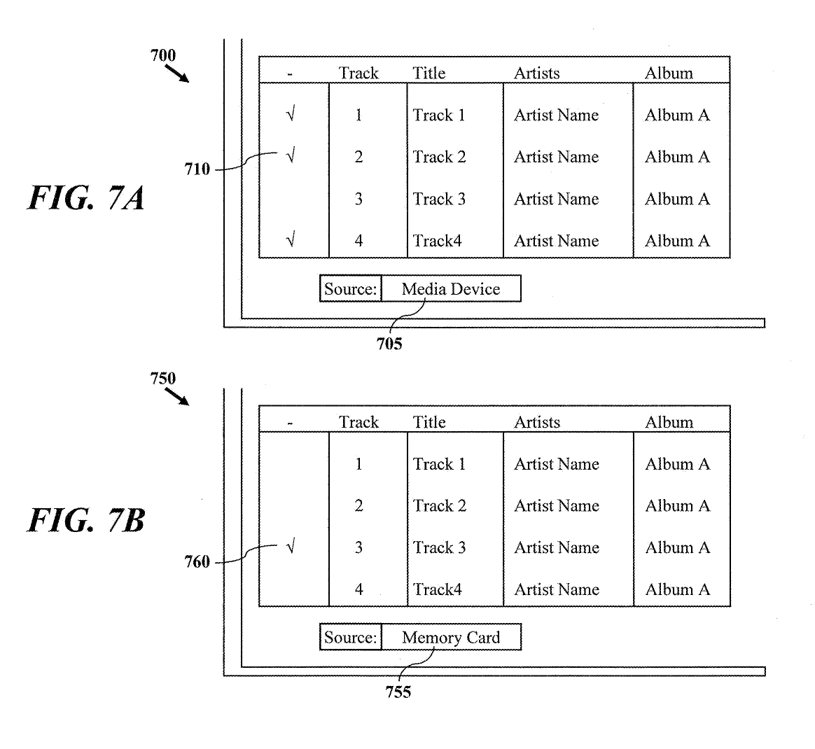

Referring now to FIGS. 7A-7B, graphical representations are depicted of graphical indicators generated by a media management application according to one embodiment of the invention. In one embodiment, graphical indicators may be displayed to represent files that also exist on a location not currently visible. Referring first to FIG. 7A, window 700 relates to a track window (e.g., window 625) based on selection of album stored in the library of the computing device. Window 700 may further allow for user selection of a device, such as a media player device, by a user in selection menu 705 (e.g., menu 620). Based on user selection of media player device in menu 700, the media management application may display one or more graphical indicators, shown as 710, to identify media files of the library which are also stored on the media player device. In one embodiment, display of graphical indicators may be based on media matching performed by the media management application of a computing device when the media player is coupled to the computing device. In another embodiment, display of graphical indicators may be based on data comparison of data stored in a media library (e.g., media library 500).

Based on user selection of a different device, such as a memory card in menu 705, the graphical display of the track window may be imitated. Referring first to FIG. 7B, media window 750 relates to a media window associated with selection of a memory card, shown as 755. Based on selection of the memory card, the media management application may display one or more graphical indicators, shown as 760.

FIG. 8 depicts a graphical representation of graphical indicators generated by a media management application according to another embodiment of the invention. According to one embodiment, windows of a user interface of a media management application may adjust or display different graphical indicators based on media matching. As depicted in FIG. 8, windows, shown as 800, of a user interface (e.g., user interface 600) may include library window 800 and track window 810. Library window 805 may provide one or more display elements associated with albums, shown as 815, stored by a computing device (e.g., computing device 400). In one embodiment, window 805 may allow for display of albums as a default symbol, shown as 820. Additionally, window 805 may allow for display of an album including album artwork, shown as 825, and/or an album icon including the album title, shown as 830. Based on a user selection window 805 may display ari indicator associated with a selected album, shown as 835.

According to one embodiment, based on a user selected album, as indicated by 835, window 810 may display one or more media files associated with the album. Based on the selected album and a device selected by menu 840, window 810 may include one or more graphical indicators, shown as 845, as described above. According to another embodiment, the user interface of the media Management application may include a graphical indicator displayed near graphical displays of an album in window 805. For example, graphical indicator 850, depicted as a check mark, may indicate that each media file associated with the album, album 830, is already stored on the media device indicated by menu 840. As such, a user does not need to toggle between windows of the interface to determine if media files match. Further, as depicted in FIG. 8, display of check mark 850 corresponds to graphical indicators for each track, shown as 845, for the selected album.

Display of indicator 850 may be based on media matching performed by the media management application of a computing device and/or data comparison of data stored in a media library (e.g., media library 500). According to another embodiment, graphical indicators may be displayed to indicate that some media files associated with an album in display window 805 are stored the media player device indicated by menu 840. For example, graphical indicator 855 indicates that at least some of the media files associated with “Album X”, stored on the computing device are additionally stored on the media player. By a user selecting “Album X”, the user interface could display one or more graphical indicators to identify tracks of the album stored on the media player in window 810. Graphical indicator 855 is depicted as an asterisk in FIG. 8, however, it should also be appreciated that other indicators may be displayed. Further, according to one embodiment, a graphical indicator illustrating that an entire album is stored in the device may relate to a solid check mark, such as 850, wherein a media indicator relating to partial storage of album files may relate to a hollow check mark (not shown in FIG. 8). Further, although windows of the user interface are depicted with respect to media files associated with one or more audio files, it may be appreciated that graphical indicators may similarly be display for other types of media files as described herein.

Although FIG. 8 has been described above with reference to matching media files, it should also be appreciated that display of graphical indicators may be employed for matching files relative to one or more computing devices in general. In one embodiment, window 800 of the user interface may be employed for displaying one or more graphical indicators associated with file matching via a network connection. For example, graphical indicators, such as 850 and 855, may be employed to identify files that exist on external storage when a management application executed y a computing device is employed to synchronize files between one or more computing devices as described herein.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for matching media files stored in a media player device to media files stored in a computing device, the method comprising the acts of:
scanning the media player device, by the computing device, for one or more media files;
detecting an identifier associated with each media file stored on the media player device, wherein identifiers are generated by a media management application;
checking, by the computing device, if detected identifiers associated with media files stored in the media player device correspond to identifiers associated with media files stored in the computing device; and
determining one or more graphical indicators for a user interface of the media management application based on said checking.

2. The method of claim 1, wherein scanning the media player device is performed when the media player device is coupled to the computing device.

3. The method of claim 1, wherein the identifiers associated with each media file relate to a persistent identification code which uniquely identifies the media file for a plurality of computing devices configured to execute the media management application.

4. The method of claim 1, wherein checking relates to comparing each identifier associated with the media files stored in the media player device to a table of identifiers in a library of the computing device.

5. The method of claim 1, wherein a graphical indicator indicates storage of a media file in the media player device when viewing media files of stored in the computing device.

6. The method of claim 1, further comprising generating a roaming identifier for a media file stored on the media player device when the media player identifier does not match an identifier stored in computing device for a particular media file.

7. The method of claim 1, further comprising determining file data associated with a media file to match data of a media file to an identifier stored in the computing device when a media file associated with the media player does not correspond to an identifier stored in the computing device.

8. The method of claim 5, further comprising matching, by the computing device, media data associated with one or more of artist, title, album and metadata for a media file stored in the media player device to data associated with media files stored in the computing device.

9. The method of claim 1, further comprising generating an identifier when a media file associated with the media player device is not stored on the computing device.

10. The method of claim 1, further comprising displaying a graphic indicator based on a media source selected by the user and one or more media files selected by the user stored on the computing device.

11. A computer program product stored on computer readable medium including computer executable code for matching media files stored by a media player to media files stored by computing device, the computer program product comprising:
computer readable code to scan the media player device for one or more media files;
computer readable code to detect an identifier associated with each media file stored on the media player device, wherein identifiers are generated by a media management application;
computer readable code to check if detected identifiers associated with media files stored in the media player device correspond to identifiers associated with media files stored in the computing device; and
computer readable code to determine one or more graphical indicators for a user interface of the media management application based on computer readable code to check.

12. The computer program product of claim 11, wherein the computer readable code to scan the media player device is executed when the media player device is coupled to the computing device.

13. The computer program product of claim 11, wherein the identifiers associated with each media file relate to a persistent identification code which uniquely identifies the media file for a plurality of computing devices configured to execute the media management application.

14. The computer program product of claim 11, wherein computer readable code to check includes computer readable code to compare each identifier associated with the media files stored in the media player device to a table of identifiers in a library of the computing device.

15. The computer program product of claim 11, wherein a graphical indicator indicates storage of a media file in the media player device when viewing media files of stored in the computing device.

16. The computer program product of claim 11, further comprising computer readable code to generate a roaming identifier for a media file stored on the media player device when the media player identifier does not match an identifier stored in computing device for a particular media file.

17. The computer program product of claim 11, further comprising computer readable code to determine file data associated with a media file to match data of a media file to an identifier stored in the computing device when a media file associated with the media player does not correspond to an identifier stored in the computing device.

18. The computer program product of claim 18, further comprising computer readable code to match media data associated with one or more of artist, title, album and metadata for a media file stored in the media player device to data associated with media files stored in the computing device.

19. The computer program product of claim 11, further comprising computer readable code to generate an identifier when a media file associated with the media player device is not stored on the computing device.

20. The computer program product of claim 11, further comprising computer readable code to display a graphic indicator based on a media source selected by the user and one or more media files selected by the user stored on the computing device.

21. A method for providing a user interface for a media management application by a computing device, the method comprising the acts of:
detecting, by the computing device, a connection to a media player device;
matching, by the computing device, media files stored in the media player device to one or more media files stored in the computing device based on detection of one or more identifiers associated with files stored in the media player device, wherein identifiers are generated by a media management application;
determining one or more graphical indicators for the user interface of the media management application based on said matching; and
displaying a user interface for the media management application based on said determining, wherein the user interface includes one or more graphical indicators.

22. The method of claim 21, wherein matching media files includes checking if identifiers associated with detected media files stored in the media player correspond to identifiers associated with media files stored in the computing device.

23. The method of claim 21, wherein a graphical indicator indicates storage of a media file in the media player device when viewing media files of stored in the computing device.

24. The method of claim 21, wherein displaying the user interface is based on a user selection of the user interface, wherein the user interface displays one or more audio files based on a selected album.

25. The method of claim 21, wherein displaying the user interface is based on a source of media files located on the computing device.

26. The method of claim 21, wherein the identifiers associated with each media file relate to a persistent identification code which uniquely identifies the media file for a plurality of computing devices configured to execute the media management application

27. The method of claim 21, further comprising generating an identifier when a media file associated with the media player device is not stored on the computing device.

28. The method of claim 21, wherein display of a graphical identifier is based on elements indicating a plurality of media files, wherein the graphical indicator identifies one of partial and complete storage of media files which are related.

29. The method of claim 21, further comprising updating display of graphical indicators based on one or more user selections of the media management application.

30. A computer program product stored on computer readable medium including executable code for providing a user interface for a media management application by a computing device, the computer program product comprising:
computer readable code to detect a connection to a media player device;
computer readable code to match media files stored in the media player device to one or more media files stored in the computing device based on detection of one or more identifiers associated with files stored in the media player device, wherein identifiers are generated by a media management application;
computer readable code to determine one or more graphical indicators for the user interface of the media management application based on said matching; and
computer readable code to display a user interface for the media management application based on computer readable code to determine, wherein the user interface includes one or more graphical indicators.

31. The computer program product of claim 30, wherein computer readable code to match media files includes computer readable code to check if identifiers associated with detected media files stored in the media player correspond to identifiers associated with media files stored in the computing device.

32. The computer program product of claim 30, wherein a graphical indicator indicates storage of a media file in the media player device when viewing media files of stored in the computing device.

33. The computer program product of claim 30, wherein computer readable code to display the user interface is based on a user selection of the user interface, wherein the user interface displays one or more audio files based on a selected album.

34. The computer program product of claim 30, wherein computer readable code to display the user interface is based on a source of media files located on the computing device.

35. The computer program product of claim 30, wherein the identifiers associated with each media file relate to a persistent identification code which uniquely identifies the media file for a plurality of computing devices configured to execute the media management application

36. The computer program product of claim 30, further comprising computer readable code to generate an identifier when a media file associated with the media player device is not stored on the computing device.

37. The computer program product of claim 30, wherein computer readable code to display a graphical identifier is based on elements indicating a plurality of media files, wherein the graphical indicator identifies one of partial and complete storage of media files which are related.

38. The computer program product of claim 30, further comprising computer readable code to update display of graphical indicators based on one or more user selections of the media management application.
